(19) United States
(12) Patent Application Publication
(10) Pub. No.: US 2026/0289701 A1
(43) Pub. Date: Sep. 24, 2026

(54) SYSTEMS AND METHODS FOR FRAUD RESISTANT CLOSING RECORD GENERATION AND VERIFICATION

(71) Applicant: Ameristract Title Insurance Company, Inc., Great Neck, NY (US)

(72) Inventors: Radni Davoodi, Roslyn, NY (US); Raymond Y. Davoodi, Roslyn Estates, NY (US)

(21) Appl. No.: 19/567,752

(22) Filed: Mar. 16, 2026

Related U.S. Application Data
(60) Provisional application No. 63/773,644, filed on Mar. 18, 2025.

(51) Int. Cl. G06Q 50/16; G06F 21/32; G06F 21/60; G06Q 40/08; H04N 7/15

(52) U.S. Cl. CPC G06Q 50/167; G06F 21/32; G06F 21/602; G06Q 40/08; H04N 7/155

(57) ABSTRACT

A virtual closing system includes a processor and a memory including instructions, which when executed by the processor, cause the system to: verify the identity of a user; access a first dataset related to the virtual closing; enable real-time electronic execution and/or notarization of the first dataset; capture an audio and/or a video recording of the virtual closing; integrate the audio and/or video recording and the first dataset to generate a second dataset; record the second dataset on a distributed ledger system; generate a title insurance policy, based on the second dataset; and transmit the second dataset to a recording authority.

### CROSS REFERENCE TO RELATED APPLICATIONS

This application claims priority to U.S. Provisional Patent Application No. 63/773,644 filed on Mar. 18, 2025, which is incorporated herein by reference in its entirety.

### TECHNICAL FIELD

The present application relates to systems and methods for virtual closing, and, more specifically, to a system and method for fraud resistant closing record generation and verification.

### BACKGROUND

In the realm of real estate and title insurance, the process of closing a deal traditionally involves numerous stakeholders, including buyers, sellers, attorneys, brokers, and notaries, each of whom needs to coordinate to finalize the closing. This process is often cumbersome, time-consuming, and susceptible to errors and fraud due to the reliance on physical documentation and in-person meetings. The complexity is further compounded by the need for secure handling of sensitive information and the requirement for accurate record-keeping with municipal authorities.

Accordingly, there is a need for an integrated and secure platform that can seamlessly connect all parties involved in a real estate and/or title insurance matter.

### SUMMARY

In accordance with aspects of the present disclosure, a virtual closing system includes a processor and a memory including instructions, which when executed by the processor, cause the system to: verify the identity of a user using biometric verification, government-issued identification validation, and/or cryptographic authentication; access a first dataset related to the virtual closing; enable real-time electronic execution and/or notarization of the first dataset; capture an audio and/or a video recording of the virtual closing; integrate the audio and/or video recording and the first dataset to generate a second dataset; record the second dataset on a distributed ledger system; and transmit the second dataset to a recording authority.

In an aspect of the present disclosure, the instructions, when executed by the processor, may further cause the system to transmit a real-time transaction using a quantum financial system (QFS).

In an aspect of the present disclosure, the user may include an owner, a broker, a lender, an appraiser, a title insurance agent, a closing agent, and/or a notary.

In an aspect of the present disclosure, enabling the real-time electronic execution and/or real-time notarization of the first dataset may include using a smart contract stored on the distributed ledger system.

In an aspect of the present disclosure, recording the second dataset on the distributed ledger system may include recording the second dataset in an encrypted format on a blockchain ledger.

In an aspect of the present disclosure, the instructions, when executed by the processor, may further cause the system to generate a cryptographic hash of the second dataset prior to transmission to the recording authority.

In an aspect of the present disclosure, the first dataset may include a deed, a transfer document, a mortgage, a note, a collateral document, an insurance policy, a title policy, a title report, and/or an affidavit.

In an aspect of the present disclosure, the instructions, when executed by the process, may further cause the system to generate a title insurance policy, based on the second dataset.

In an aspect of the present disclosure, the system may further include a gateway configured to directly interface with the recording authority.

In an aspect of the present disclosure, the recording authority may be a county clerk office.

In accordance with aspects of the present disclosure, a virtual closing method includes verifying the identity of a user using biometric verification, government-issued identification validation, and/or cryptographic authentication; accessing a first dataset related to the virtual closing; enabling real-time electronic execution and/or notarization of the first dataset; capturing an audio and/or a video recording of the virtual closing; integrating the audio and/or video recording and the first dataset to generate a second dataset; recording the second dataset on a distributed ledger system; and transmitting the second dataset to a recording authority.

In an aspect of the present disclosure, the method may further include transmitting a real-time transaction using a quantum financial system (QFS).

In an aspect of the present disclosure, the user may include an owner, a broker, a lender, an appraiser, a title insurance agent, a closing agent, and/or a notary.

In an aspect of the present disclosure, enabling the real-time electronic execution and/or real-time notarization of the first dataset may include using a smart contract stored on the distributed ledger system.

In an aspect of the present disclosure, recording the second dataset on the distributed ledger system may include recording the second dataset in an encrypted format on a blockchain ledger.

In an aspect of the present disclosure, the method may further include generating a cryptographic hash of the second dataset prior to transmission to the recording authority.

In an aspect of the present disclosure, the first dataset may include a deed, a transfer document, a mortgage, a note, a collateral document, an insurance policy, a title policy, a title report, and/or an affidavit.

In an aspect of the present disclosure, the method may further include generating a title insurance policy, based on the second dataset.

In an aspect of the present disclosure, a gateway may be configured to directly interface with the recording authority.

In accordance with aspects of the present disclosure, a non-transitory computer readable storage medium includes instructions that, when executed by a computer, cause the computer to perform a virtual closing method, including: verifying the identity of a user using biometric verification, government-issued identification validation, and/or cryptographic authentication; accessing a first dataset related to the virtual closing; enabling real-time electronic execution and/or notarization of the first dataset; capturing an audio and/or a video recording of the virtual closing; integrating the audio and/or video recording and the first dataset to generate a second dataset; recording the second dataset on a distributed ledger system; and transmitting the second dataset to a recording authority.

### BRIEF DESCRIPTION OF THE DRAWINGS

A better understanding of the features and advantages of the disclosed technology will be obtained by reference to the following detailed description that sets forth illustrative embodiments, in which the principles of the technology are utilized, and the accompanying drawings of which:

FIG. 1 is a diagram of an exemplary networked environment for a virtual closing system, in accordance with aspects of the present disclosure;

FIG. 2 is a block diagram of example components of the virtual closing system of FIG. 1, in accordance with aspects of the present disclosure;

FIG. 3 is an exemplary illustration of the virtual closing system of FIG. 1, in accordance with aspects of the present disclosure;

FIG. 4 is a diagram of an exemplary workflow of the virtual closing system of FIG. 1, in accordance with aspects of the present disclosure;

FIG. 5 is a block diagram of example data stored in a distributed ledger integrated with the virtual closing system of FIG. 1, in accordance with aspects of the present disclosure; and

FIG. 6 is an exemplary method of using a virtual closing system, in accordance with aspects of the present disclosure.

### DETAILED DESCRIPTION

The present application relates to systems and methods for a virtual closing platform.

The virtual closing system discussed herein integrates blockchain technology, quantum financial systems, and/or automated verification processes to create a secure, efficient, and legally compliant digital real estate closing platform. Unlike traditional closing methods that rely on manual document handling, in-person meetings, and fragmented financial transactions, the virtual closing system streamlines the entire workflow by enabling real-time collaboration among buyers, sellers, lenders, attorneys, and/or title agents through a cloud-based, blockchain-backed infrastructure. The distributed ledger system ensures transparency and immutability by securely recording all executed documents, notarizations, and financial transactions, thereby reducing fraud risks and simplifying regulatory compliance. Additionally, real-time authentication measures, including biometric verification and/or cryptographic security protocols, ensure that only authorized participants can access and execute documents, mitigating identity fraud and unauthorized alterations.

The integration with blockchain and title insurance technology further enhances security and efficiency, thus providing a secure, cloud-based environment that records all aspects of the closing process. Additionally, the virtual closing system facilitates electronic execution and notarization of documents while supporting disbursement through multiple payment systems, including cryptocurrency platforms such as XRP, international platforms, and/or traditional banking methods. The ability to archive the entire transaction on the blockchain for future reference enhances traceability, auditability, and fraud prevention, addressing the inefficiencies and security vulnerabilities inherent in existing real estate closing processes. By combining these cutting-edge technologies, the disclosed system revolutionizes the real estate closing industry by offering a faster, more secure, and fully digital alternative to conventional closing methods.

As used herein, a “virtual closing system” may include a digital platform configured to facilitate the execution, verification, and/or recording of real estate operations in a secure, automated, and legally compliant manner. The virtual closing system may integrate multiple components to manage user interactions, document execution, financial transactions, and title insurance processes, enabling a seamless, end-to-end virtual closing experience.

As used herein, a “user interface” may include a front-end application configured to allow users to interact with a virtual closing system. The user interface may provide access to features such as user registration, scheduling, document uploads, and/or communication tools, allowing participants to engage in the virtual closing process efficiently and securely.

As used herein, a “closing interface” may include a dedicated interface configured to enable users to engage in the virtual real estate closing process. The closing interface may include functionalities for document review, electronic signing, notarization, and/or real-time interactions via video and audio conferencing, ensuring a structured and legally compliant closing workflow.

As used herein, a “data capture system” includes a system configured to collect, store, and manage data throughout a virtual closing process. The data capture system is configured to record user inputs, document versions, digital signatures, biometric authentication events, and audio or video recordings by generating event records that include at least an event type, an event timestamp, a participant identifier, a document identifier, and a cryptographic hash of the associated document content. The data capture system stores the event records in an append only log and stores document binaries and media binaries in an object store. The data capture system generates a closing manifest that references each stored binary using a content address, including a hash value, a storage URI, a file type, and a version identifier.

As used herein, a “distributed ledger system” may include a blockchain-based or decentralized system configured to record and secure transaction data, including executed documents, digital signatures, and/or title records. The distributed ledger system may be configured to ensure transparency, immutability, and fraud prevention by providing a permanent, verifiable record of all closing-related activities.

As used herein, a “settlement system” may include a processing system configured to facilitate the disbursement of funds necessary to complete the closing process. The settlement system may be configured to support various payment methods, including wire transfers, international transactions, cryptocurrency payments, XRP and/or Ripple platforms, and quantum financial systems (QFS), ensuring flexible and secure settlement.

As used here, a “title insurance system” may include a component configured to integrate title insurance services into a virtual closing system. The title insurance system may be configured to enable title agents and underwriters to perform ownership verification, lien searches, policy issuance, and/or risk assessments, ensuring real estate operations are protected from title defects, fraudulent claims, and legal disputes.

As used herein, “users” and/or “participants” may include individuals or entities configured to participate in the virtual closing process. These users and/or participants may include buyers, sellers, real estate brokers, attorneys, mortgage lenders, title insurance agents, notaries, and/or other authorized parties, each having a defined role within the transaction workflow.

As used herein, a “central server” may include a cloud-based and/or decentralized computing infrastructure configured to host, process, and secure transaction data, user records, and digital documents. The central server may be configured to ensure seamless access, synchronization, and storage of all closing-related information, enabling real-time collaboration among users.

As used herein, a “recording entity” may include a governmental or regulatory office, such as a county clerk office or municipal recording office, configured to officially record executed real estate documents. The recording entity may be configured to ensure that deeds, mortgages, title transfers, and other closing-related documents are legally recorded, establishing a verifiable public record of the transaction.

For the purpose of promoting an understanding of the principles of the present disclosure, reference will now be made to exemplary embodiments illustrated in the drawings, and specific language will be used to describe the same. It will nevertheless be understood that no limitation of the scope of the present disclosure is intended. Various alterations, rearrangements, substitutions, and modifications of the features illustrated herein, and any additional applications of the principles of the present disclosure as illustrated herein, which would occur to one skilled in the relevant art and having possession of this disclosure, are to be considered within the scope of the present disclosure.

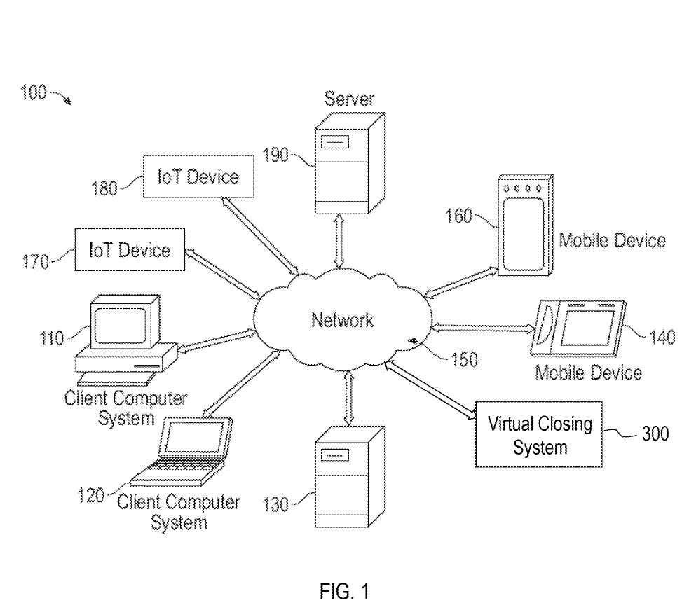

Referring to FIG. 1, an exemplary networked environment 100 for virtual closing is shown in accordance with aspects of the present disclosure. The network environment 100 includes one or more client computer systems 110, 120, a cloud system 130, a network 150, one or more mobile devices 140, 160, one or more IOT devices 170, 180, a server 190, and a virtual closing system 300. The client computer systems 110, 120 communicate with the server 190 across the network 150. It is contemplated that multiple servers 190 may be used in a distributed architecture and/or in a cloud.

The server 190 provides a repository of instrumented OSS components that may be accessed by developers and/or by build automation software at the client computer systems 110, 120 to build applications. The term “application” may include a computer program designed to perform particular functions, tasks, or activities. An application may be software or firmware and may be deployed on any platform, such as on the client computer systems 110, 120, on mobile devices 140, 160, and/or on IOT devices 170, 180, among others, such as, but not limited to, consumer electronics, networking devices, enterprise systems, etc. An application may refer to, for example, software running locally or remotely, as a standalone program or in a web browser, or other software which would be understood by one skilled in the art to be an application. In embodiments, an application may run on a server and/or on a user device. Two client computer systems 110, 120 are illustrated as examples, but more than two client computer systems may exist in networked environment 100.

The network 150 may be wired or wireless, and can utilize technologies such as Wi-Fi, Ethernet, Internet Protocol, 4G, and/or 5G, or other communication technologies. The network 150 may include, for example, but is not limited to, a cellular network, residential broadband, satellite communications, private network, the Internet, local area network, wide area network, storage area network, campus area network, personal area network, or metropolitan area network.

The illustrated networked environment of networked environment 100 is merely exemplary. In embodiments, other systems, servers, and/or devices not illustrated in FIG. 1 may be included. In embodiments, one or more of the illustrated components may be omitted. Such and other embodiments are contemplated to be within the scope of the present disclosure.

The systems and methods described herein are not limited to real estate or mortgage transactions and may be used to generate and verify tamper-evident transaction records for other industries that involve multi-party execution of regulated or high-value documents. For example, the virtual closing system may be configured to support one or more of business formation and corporate governance workflows, mergers and acquisitions document execution, insurance policy issuance and claims settlements, vehicle and equipment title transfers, secured lending transactions, supply chain and logistics attestations, healthcare consent and authorization workflows, and other transactions requiring identity verification, controlled document versioning, audio/video evidence capture, and creation of a verifiable record package suitable for third-party audit or submission to an external authority.

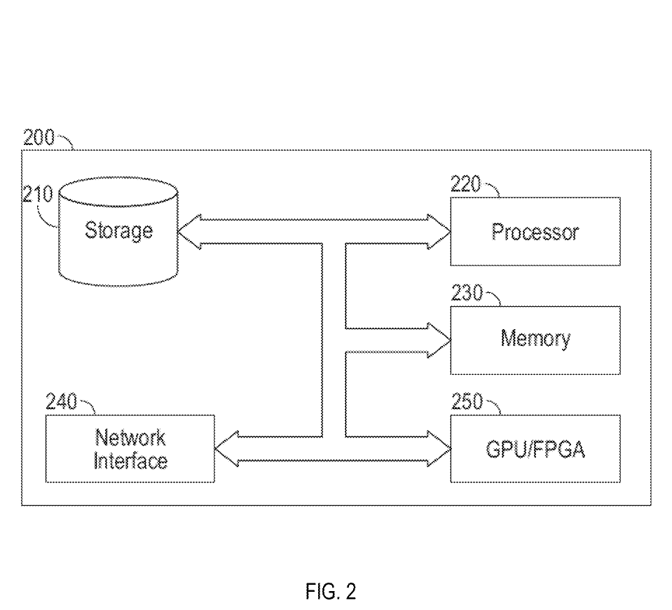

Referring now to FIG. 2, there is shown a block diagram of example components of any of the systems, devices, and/or servers of FIG. 1 (e.g., a controller) in accordance with aspects of the present disclosure. The components include an electronic storage 210, a processor 220, a memory 230, a network interface 240, and a graphical processing unit (GPU) 250 among other components that persons skilled in the art will recognize. The various components may be communicatively coupled with each other. The processor 220 may be and may include any type of processor, such as a single-core central processing unit (CPU), a multi-core CPU, a microprocessor, a microcontroller, a digital signal processor (DSP), a System-on-Chip (SoC), an application specific integrated circuit (ASIC), or any other type of processor. The memory 230 may be a volatile type of memory, e.g., RAM, or a non-volatile type of memory, e.g., NAND flash memory. The memory 250 includes processor-readable instructions that are executable by the processor 220 to cause the systems, devices, and/or servers to perform various operations, including those mentioned herein. The GPU 250 may be used for processing machine learning network models.

The electronic storage 210 may be and include any type of electronic storage used for storing data, such as hard disk drive, solid state drive, and/or optical disc, among other types of electronic storage. The electronic storage 210 stores processor-readable instructions for causing the systems, devices, and/or servers to perform operations and store data associated with such operations. The network interface 240 may implement wireless networking technologies and/or wired networking technologies.

The components shown in FIG. 2 are merely examples, and persons skilled in the art will understand that systems, devices, and/or servers include other components not illustrated and may include multiples of any of the illustrated components. Such and other embodiments are contemplated to be within the scope of the present disclosure.

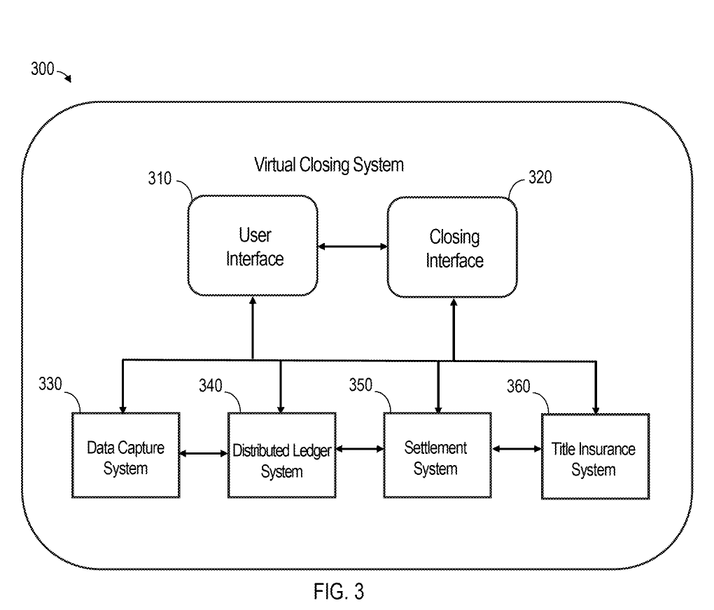

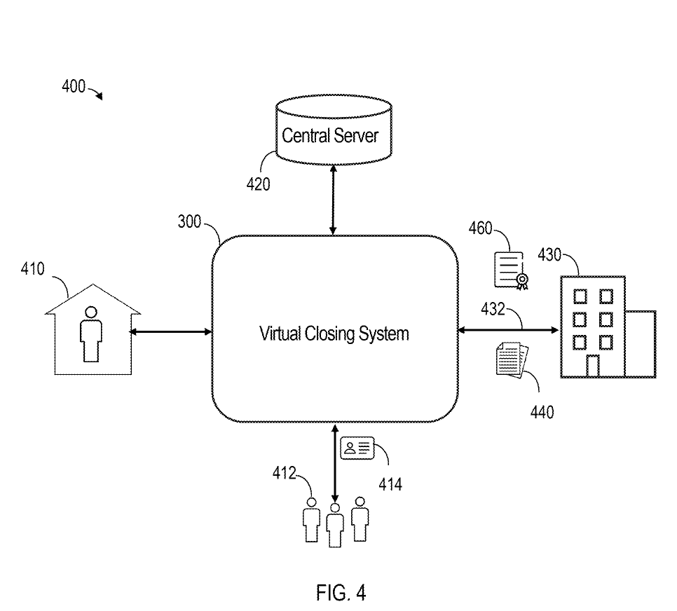

Referring now to FIGS. 3 and 4, there is shown an exemplary illustration of the virtual closing system 300 of FIG. 1, and a workflow 400 thereof, in accordance with aspects of the present disclosure. The virtual closing system 300 generally includes a user interface 310, a closing interface 320, a data capture system 330, a distributed ledger system 340, a settlement system 350, and a title insurance system 360. The workflow 400 includes the virtual closing system 300, users 410, 412, a central server 420, and/or a recording entity 430. The data capture system 330, distributed ledger system 340, settlement system 350, and title insurance system 360, and/or any components of the workflow 400 may operate in a parallel manner, thereby enabling real-time data synchronization, reducing processing delays, and ensuring that transactional, financial, and legal verifications occur simultaneously to streamline the virtual closing process while maintaining accuracy, security, and compliance.

The user interface 310 may enable a user (e.g., user 410, 412 in FIG. 4) to register for and/or manage an account associated with the virtual closing system 300. Such a user 410, 412 may include an owner, seller, attorney, buyer, real estate broker, mortgage broker, mortgage lender, bank, appraiser, title insurance agent, title closer, notary public, bank closing agent, title insurance underwriter, homeowner’s insurance agent, flood insurance agent, and/or other parties involved in and/or associated with the closing process. For example, user 410 may be a homeowner (e.g., the seller) and users 412 may include the buyer, attorney(s), broker, notary, and/or other additional parties.

Through the user interface 310, a user may input required credentials, personal details, and/or authentication information to establish an account. For example, the user 410 may specify their role within a virtual closing, such as a buyer, seller, lender representative, escrow agent, and/or notary. In aspects, during registration, the user interface 310 may request specific details relevant to a designated role. For example, a buyer may be required to enter personal identification information and financing details, whereas a notary may need to submit certification credentials. The user interface 310 may also facilitate updates to user account information, role designation, and/or other relevant data to ensure accurate participation in the virtual closing process.

The user interface 310 may further enable scheduling of a closing, such as a virtual real estate closing, through the virtual closing system 300. During the scheduling process, the user interface 310 may request key meeting details, such as a desired date, time, and/or time zone for the closing. In aspects, the user interface 310 may provide options for selecting a virtual meeting format, such as a video conferencing session similar to Webex^{®}, Zoom^{®}, and/or Microsoft Teams^{®}, to facilitate real-time interaction among participants. Other relevant parties (e.g., users 412) may be invited to participate in the closing, such as the buyer, seller, real estate brokers, attorneys, mortgage lenders, title insurance agents, notaries, and/or other professionals involved in the closing. In aspects, the invitation(s) may be sent through various communication channels, such as email, text message, and/or in-app notifications, ensuring that participants receive timely and secure access.

In aspects, the scheduling process may further include pre-verification measures to enhance security and authentication, such as requesting verification data. Generally, the pre-verification measures may be sent with the invitation, and/or presented as a prompt prior to entering the closing session. For example, verification data may be required immediately before entering the virtual closing session, such that users 410, 412 attempting to enter the closing interface 320 may be prompted to undergo real-time authentication through automated or live verification processes. The pre-verification measures ensure that only authorized users 410, 412 can access the virtual closing session, enabling the prevention of fraud, unauthorized participation, and/or identity misrepresentation. The verification data may include government-issued identification and/or professional licenses. For example, government-issued identification may include documents such as a driver’s license, passport, or national ID card. Professional licenses may be required for individuals such as real estate brokers, attorneys, mortgage lenders, title insurance agents, notaries, and/or appraisers to confirm their credentials and legal authority to participate in the closing.

In aspects, biometric authentication (e.g., facial, vocal, and/or fingerprint authentication) may be utilized as an additional security layer to verify user identity through advanced identity recognition methods. For example, recognition technology may compare a user’s facial features against official records, voice verification may authenticate users based on their unique vocal characteristics, and/or fingerprint scanning may be used to confirm identity through fingerprint recognition technology. These authentication methods may be implemented individually and/or in combination to ensure a secure and reliable verification process.

In aspects, identity verification may include capturing one or more biometric samples and one or more identification artifacts and generating corresponding verification artifacts stored as content-addressed artifacts. For example, the system may capture a face image, fingerprint sample, and/or other biometric sample, capture an image of a government-issued identification document, and generate verification artifacts that include biometric template data, liveness-detection outcomes, device identifiers, and timestamps. The data capture system may write an identity-verification event record to the append-only log that references the verification artifacts by content hash, thereby enabling later validation that the participant who executed and/or notarized documents corresponds to the participant who completed the recorded identity proofing.

Once a user 410, 412 successfully completes the pre-verification process, the virtual closing system 300 may generate and store a verification token and/or digital certificate confirming authentication status. The verification token may be used to streamline re-authentication in the event that the user 410, 412 disconnects from the virtual closing session and needs to rejoin. By implementing these enhanced security measures, the virtual closing system 300 ensures that all parties involved in the virtual closing are properly identified and authorized, reducing the risk of fraud.

Generally, all data entered into the user interface 310 by a user 410, 412 is captured and/or stored via data capture system 330 as a user record 414. The data capture system 330 may collect and log various forms of user input, including registration details, authentication credentials, transactional data, and interaction history within the virtual closing system 300. For example, the data capture system 330 may record the user profile details such as name, contact information, role in the closing (e.g., buyer, seller, lender, attorney, notary), and/or any required verification data, thereby creating a comprehensive user record 414. The user record 414 may be stored within the virtual closing system 300 and/or on the central server 420, ensuring secure and structured access to user data. In aspects, the data capture system 330 may maintain encrypted storage to safeguard sensitive user information while allowing authorized parties to retrieve necessary details for compliance, auditing, and/or future matters. Additionally, the data capture system 330 may facilitate real-time synchronization of each user record 414 across multiple components of the virtual closing system 300, ensuring consistency and integrity of information throughout the virtual closing process.

The closing interface 320 enables users (e.g., users 410, 412 in FIG. 4) to conduct a closing, such as a virtual real estate closing. Generally, the closing interface 320 is designed to facilitate the entire closing process, ensuring a seamless and secure user experience. For example, the closing interface 320 provides a centralized platform for document management and execution. Prior to and/or during the closing, a comprehensive set of documents 440 related to the closing may be uploaded. The documents 440 may include various legal, financial, and contractual records necessary for completing the real estate closing process. The uploaded documents 440 may be categorized into different groups based on their purpose, such as transaction documents (e.g., records that define the terms of the real estate closing, including the deed, mortgage agreement, promissory note, title policy, transfer documents, and affidavits), documents for discussion and review (e.g., materials that require review and verification by the involved parties, such as the title report/title commitment, insurance policies including homeowner’s, flood, and title insurance, collateral documents, and financial disclosures), and/or documents for execution (e.g., legal instruments that must be electronically signed and notarized by the relevant parties, including purchase agreements, closing disclosures, settlement statements, and any required regulatory compliance forms).

During the virtual closing session, the closing interface 320 ensures an organized and structured workflow by presenting documents 440 for review and execution one at a time. For example, users 410 are required to confirm that each document 440 has been reviewed before proceeding to the next step. In aspects, the closing interface 320 may implement interactive validation mechanisms, such as checkboxes and/or confirmations, to track document acknowledgment. Once reviewed, the documents 440 are electronically signed (e-signed) by the respective parties in sequence to maintain the integrity of the closing process. This step-by-step review process is crucial for maintaining the integrity of the closing. In aspects, to comply with legal and regulatory requirements, all documents 440 must also be electronically notarized (e-notarized) in real time within the virtual closing platform, thereby providing an additional layer of legal validation and security. This comprehensive approach ensures that all aspects of the closing are conducted in a secure, efficient, and legally compliant manner. In aspects, the system may verify participant identities through authentication measures such as government-issued ID collection, biometric verification (e.g., facial recognition, voice authentication, and fingerprint scanning), and/or professional license validation before permitting the notarization process, similar to authorization prior to entering the closing session.

Generally, all data entered into the closing interface 320 is captured and/or stored via the data capture system 330 as a closing record 450. The data capture system 330 may track various interactions and transactional data during the virtual closing process to ensure accuracy, compliance, and secure record-keeping. For example, as users review, execute, and notarize documents 440 within the closing interface 320, the data capture system 330 may record each document 440 and/or log timestamps, participant actions, authentication confirmations, and/or document version histories, thereby creating a comprehensive closing record 450. In aspects, the closing record 450 may include digital signatures, electronic notarization details, and/or any approvals or acknowledgments provided by the users 410, 412 involved in the closing. Additionally, any modifications, annotations, and/or confirmations made to documents 440 within the closing interface 320 may be stored as part of the closing record 450, ensuring a transparent and auditable closing process. The collected data and/or the closing record 450 may be stored within the virtual closing system 300 and/or on the central server 420, which ensures that all relevant data is readily accessible for regulatory compliance, post-closing verification, and potential dispute. In aspects, the virtual closing system 300 may generate a detailed metadata log that records every action taken by each participant throughout the virtual closing, including timestamps, IP addresses, identity verification and/or system-generated hash values representing document integrity, ensuring no unauthorized modifications were made.

In aspects, both video and audio recording of the closing interface 320 may be acquired by the data capture system 330 during the closing process. The data capture system 330 may continuously record the virtual closing session, including all interactions, discussions, and document executions, which may be stored as part of the closing record 450. This recording may encompass video feeds from participants, screen-sharing activities, audio conversations, and real-time document signing or notarization actions. For example, as parties engage in the virtual closing, the system may capture and store video footage of attendees verifying their identities, reviewing documents, providing consent, and executing legally binding agreements. Similarly, the audio recording may document verbal confirmations, instructions, and discussions between buyers, sellers, attorneys, lenders, and notaries to ensure that all communications related to the closing are preserved. Thus, the video and/or audio recording enhances security and fraud prevention by creating an immutable record of the closing session, which can be referenced in case of disputes or fraudulent claims, while simultaneously ensuring compliance with legal and regulatory requirements. Moreover, the recording facilitates post-closing verification and auditing, allowing authorized parties to review the details and confirm that all steps were completed correctly.

Following execution and notarization, all e-signed and/or e-notarized documents 440 may be submitted to the appropriate recording entity 430 (e.g., county clerk office and/or municipal office) for electronic recording (e-recording) via an integrated gateway 432. The e-recording process ensures that legally binding real estate closing documents are officially recorded in public records, maintaining compliance with jurisdictional requirements and establishing an authoritative record of ownership transfers, liens, and other property-related legal instruments. For example, the gateway 432 may be directly integrated with the closing interface 320 through cloud-based utility software, allowing for the seamless transmission of executed documents 440 from the virtual closing system 300 to the recording entity 430. The gateway 432 may facilitate real-time validation and/or automated submission of necessary documents 440, ensuring that all required filings are promptly and accurately processed. Additionally, the gateway 432 may support multiple submission formats, such as PDF, XML, and/or other jurisdiction-approved digital formats, to accommodate varying municipal or county clerk office requirements.

In aspects, the gateway 432 and/or the virtual closing system 300 may also obtain certification receipts 460 from the appropriate recording entity 430 upon successful submission and processing of documents. The certification receipts 460 serve as official confirmations that the closing has been recorded, providing proof of compliance and completion. The recorded documents 440, along with their corresponding certification receipts 460, may then be stored within the virtual closing system 300 and/or on the central server 420, ensuring secure archival and retrieval for future reference.

In aspects, upon receipt of a recording confirmation (e.g., a municipal receipt, certification receipt, instrument number, or recording timestamp), the gateway may store the recording confirmation as a content-addressed artifact and may update the closing manifest to reference the recording confirmation artifact. The system may thereby bind municipal recording outcomes to the same integrity model used for documents and media, enabling third parties to verify, using the receipt identifier and the package hash recorded on the distributed ledger system, that the recorded instrument corresponds to the executed document version and the captured session evidence.

The virtual closing system 300 includes a distributed ledger system 340 configured to integrate with blockchain technology or similar peer-to-peer (P2P) networks, thereby providing a significant benefit over traditional closing systems. By leveraging blockchain, the distributed ledger system 340 establishes a decentralized and immutable method for handling virtual real estate closings, ensuring that all closing data is securely recorded, tamper-resistant, and verifiable. Moreover, blockchain technology further enhances the security and transparency of title insurance by allowing title policies, ownership histories, and lien records to be immutably stored on a decentralized ledger. The closing records 450, which include a comprehensive record of the entire closing session (e.g., including video and/or audio recording and the executed and/or notarized documents 440 and certification receipts 460), may be stored in a blockchain-verified record 342, e.g., creating blockchain reportable instruments stored on a blockchain ledger. The blockchain reportable instruments may be used for insurance purposes, legal verification, financial audits, and regulatory compliance. This approach ensures that all data associated with the closing is permanently recorded and time-stamped, enhancing transparency, fraud prevention, and regulatory compliance. For example, title insurance companies may utilize blockchain-verified records 342 to verify property ownership history and/or recorded encumbrances, thereby reducing risks associated with fraudulent claims. Additionally, by tying the buyer to the seller in a decentralized, cryptographic manner, blockchain-verified records 342 can provide a verifiable history that is independent of traditional county or municipal recording systems.

In aspects, the blockchain-verified records 342 may include multiple layers of data recording, such as smart contracts that automate and enforce terms, cryptographic signatures verifying document authenticity, and/or decentralized identifiers (DIDs) linking each participant to their role within the closing process. For example, smart contracts may be deployed on the blockchain to automate and enforce key terms of the closing process. A smart contract could be programmed to execute disbursement only when all required parties have electronically signed and notarized the closing documents. If any required step is incomplete (e.g., a missing notary acknowledgment) the smart contract would prevent the transaction from proceeding until compliance is met. This reduces the risk of errors, fraud, or unauthorized modifications.

In aspects, the decentralized ledger system 340 may support multi-signature verification for added security, requiring consensus among authorized parties (e.g., buyer, seller, lender, and notary) before finalizing and recording the closing details. For example, the system may require the buyer, seller, lender, and notary to all provide cryptographic approval before executing the transfer of ownership. This multi-signature approach ensures that no single entity can unilaterally complete or alter the transaction without the necessary approvals. In aspects, each e-signed and/or e-notarized document 440 stored in the blockchain ledger may include a hashed digital fingerprint, ensuring that any alterations or tampering attempts can be immediately detected.

The virtual closing system 300 includes a settlement system 350 configured to facilitate the secure and automated disbursement of funds necessary to complete the closing process. The settlement system 350 ensures that all financial transactions related to the real estate closing are processed efficiently, securely, and in compliance with regulatory requirements. The funds may be submitted to the closing interface 320 through various financial mechanisms, including traditional banking systems (e.g., US currency transactions processed via federal deposit insurance corporation (FDIC) wire protocols, international currency exchanges (e.g., foreign exchanged (FOREX) platforms), cryptocurrency platforms, and/or emerging quantum financial systems (QFS).

In aspects, the settlement system 350 may be designed to handle digital asset transactions involving blockchain-based digital wallets, XRP platforms, and/or other decentralized financial (DeFi) systems that enable buyers and lenders to send and receive reimbursement in cryptocurrencies such as Bitcoin (BTC), Ethereum (ETH), and Ripple’s XRP. The integration of XRP platforms with the settlement system 350 enables fast, low-cost, cross-border settlements, therefore providing a benefit over traditional banking channels.

In aspects, the settlement system 350 also provides the benefit of QFS integration, thereby enabling enhanced transaction speeds, near-instant settlement capabilities, and superior data encryption mechanisms that eliminate third-party intermediaries and significantly reduce transaction processing costs. QFSs represent a new paradigm in secure, instantaneous, and fraud-resistant financial transactions by leveraging quantum computing, artificial intelligence (AI), and blockchain-based ledger technology. For example, the settlement system 350 may use quantum-encrypted ledgers to verify, validate, and execute a transaction in real time, ensuring that funds are securely transferred to the designated recipient (e.g., a seller, lender, or escrow agent). The QFS integration also provides full transaction transparency while preventing hacking attempts, double-spending issues, and financial fraud, thereby providing an additional benefit over traditional and blockchain-based financial systems.

The virtual closing system 300 includes a title insurance system 360 configured to integrate title insurance services, thus ensuring real estate transactions are protected against title defects, ownership disputes, and/or other legal risks. The title insurance system 360 streamlines the process of verifying property ownership history, identifying encumbrances, and issuing title insurance policies by providing seamless digital integration with public and private records. Through the closing interface 320, title insurance agents and underwriters can actively participate in the transaction workflow, ensuring that all necessary title searches, risk assessments, and policy issuance steps are completed before finalizing the closing. The title insurance system 360 may support e-signatures and electronic notarization, allowing title agents and other authorized parties to finalize and store the policy digitally. In aspects, the title insurance system 360 may generate a title insurance record 362.

In aspects, title insurance system 360 may facilitate automated title searches by accessing public land records, blockchain-stored property histories, and/or jurisdictional databases, allowing for real-time risk assessment and mitigation. For example, when a buyer submits a real estate purchase request, the title insurance system 360 may automatically pull deed history, mortgage liens, tax records, and pending legal claims associated with the property. If an issue is detected, such as an outstanding mortgage balance or an unresolved ownership dispute, the title insurance system 360 may generate an alert for further investigation, ensuring that title defects are identified and resolved before the transaction proceeds. Once verified, the title insurance policy can be digitally generated, reviewed, and/or electronically executed within the platform, ensuring all parties receive legally binding coverage documentation.

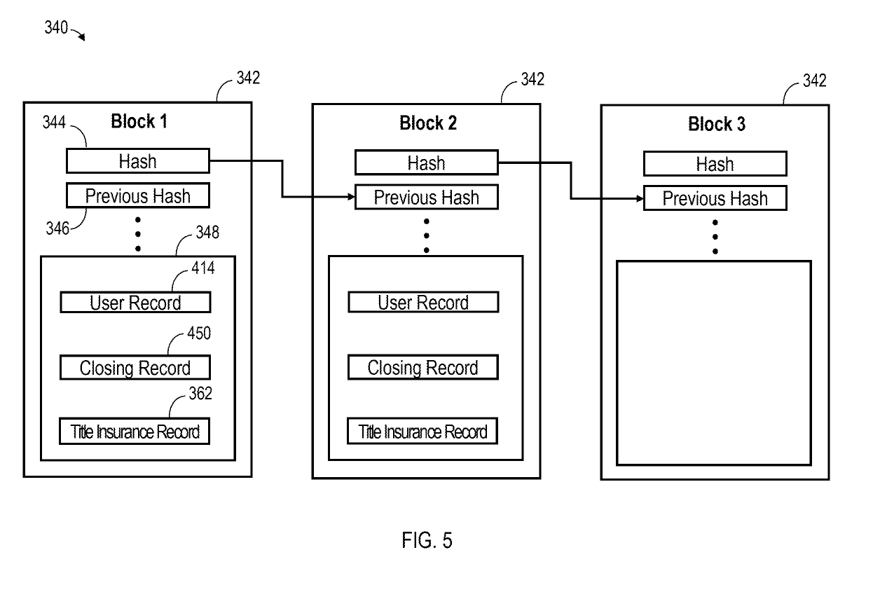

FIG. 5 illustrates exemplary blockchain-verified records 342 within the distributed ledger system 340, in accordance with aspects of the present disclosure. The blockchain-verified records 342 demonstrate how blockchain technology ensures the integrity and security of the virtual closing process. Each blockchain-verified record 342 operates as a block within the blockchain. Generally, each blockchain-verified record 342 includes a hash 344, a previous hash 346, and data 348. The hash 344 functions as a unique identifier for the corresponding blockchain-verified record 342, generated based on the block’s contents, which ensures immutability as any alteration to the block's data would produce a different hash, signaling potential tampering. The previous hash 346 links each block to the preceding block in the chain, establishing a cryptographic connection between successive records. This linkage forms a continuous, tamper-resistant sequence of transactions, where modifying one block would necessitate changes to all subsequent blocks, thereby providing an additional layer of security. For example, the hash 344 in a first blockchain-verified record 342 (e.g., block 1) is associated with the previous hash 346 of a second blockchain-verified record 342 (e.g., block 2). By leveraging blockchain's immutable and decentralized nature, the distributed ledger system 340 ensures that closing information remain secure, verifiable, and resistant to fraud or unauthorized modifications.

The data 348 contained within each blockchain-verified record 342 represents essential transaction-related information. In the context of real estate transactions, this data may include the user record 414 (e.g., information identifying the parties involved in the transaction, such as buyers, sellers, and lenders), the closing record 450 (e.g., details regarding the completion of the real estate transaction, including final agreements, executed contracts, and payment verification), and/or the title insurance record 362 (e.g., information concerning title insurance policies issued for the property). It is contemplated that additional information related to the virtual closing, such as smart certificates, collateral documents, and/or other details may be stored on each blockchain-verified record 342 to further enhance transaction security and transparency.

In aspects, a verification workflow may include receiving the receipt identifier from a requester, retrieving the ledger entry corresponding to the receipt identifier, retrieving the closing manifest referenced by the ledger entry (e.g., from the object store using a locator in the ledger entry or via an index), re-computing the package hash over the retrieved manifest and selected event records, and comparing the re-computed package hash to the package hash recorded on the distributed ledger system. If the values match, the verifier may retrieve any referenced artifact (executed document binaries, notarization payloads, audio/video segments, and municipal recording confirmations) using the content hashes in the closing manifest and validate that each retrieved artifact hashes to the expected value, thereby detecting substitution or alteration.

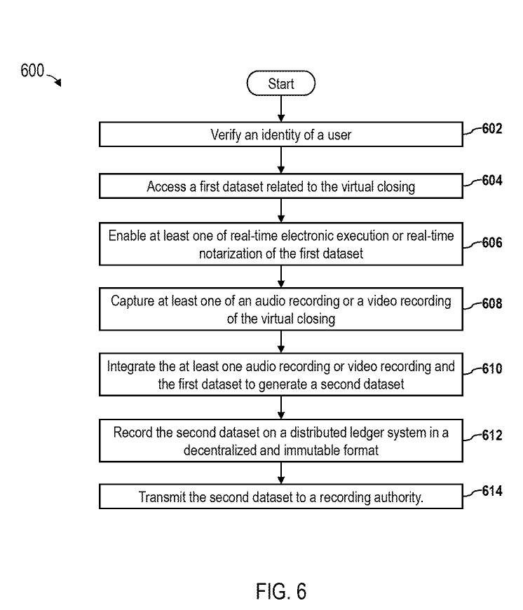

FIG. 6 shows a method 600 for an exemplary use of the virtual closing system 300. Although the steps of method 600 of FIG. 6 are shown in a particular order, the steps need not all be performed in the specified order, and certain steps can be performed in another order. For example, FIG. 6 will be described below with a server performing the operations. In other aspects, the method 600 of FIG. 6 may be performed all or in part by another device, for example, a mobile device and/or a client computer system. These and other variations are contemplated to be within the scope of the present disclosure.

Initially, at step 602, the controller 200 causes the virtual closing system 300 to verify an identity of a user 410, 412, ensuring that only authorized individuals can participate in the virtual closing process. The user 410, 412 may include an owner, a broker, a lender, an appraiser, a title insurance agent, a closing agent, a notary, and/or another individual involved in the closing process. The virtual closing system 300 may verify the identity of the user 410, 412 through multi-factor authentication, which may include government-issued ID verification, biometric authentication (e.g., facial recognition or fingerprint scanning), and/or blockchain-based identity credentials. For example, if a buyer is completing a virtual real estate closing, they may log into the virtual closing system 300 using registered credentials. Thereafter, the user 410, 412 will undergo identity verification using a secure biometric scan before being allowed to access the closing documents. In aspects, the verification may be performed in whole or in part by the data capture system 330.

Next, at step 604, the controller 200 causes the virtual closing system 300 to access a first dataset related to the virtual closing, ensuring all necessary transaction-related documents are retrieved. The first dataset may include documents 440 such as a deed, a transfer document, a mortgage, a note, a collateral document, an insurance policy, a title policy, a title report, or an affidavit. These documents 440 are typically securely accessed from a digital repository, ensuring they are up to date and have not been altered. For example, if a buyer is purchasing a home with a mortgage, the virtual closing system 300 would request upload of and/or retrieve a mortgage agreement, title report, and/or property deed from the appropriate databases, allowing all parties to review and prepare for closing. In aspects, the virtual closing system 300 may interface with various externals databases to automatically retrieve the documents 440. In aspects, the first dataset may also include a user record 414 and/or other relevant information for the closing process.

Next, at step 606, the controller 200 causes the virtual closing system 300 to enable real-time electronic execution and/or real-time notarization of the first dataset (e.g., documents 440), ensuring that all required documents 440 can be legally signed and notarized. The virtual closing system 300 integrates with electronic signature platforms and remote online notarization (RON) tools, allowing users 410, 412 to sign digitally from any location. For example, a buyer and their lender can use the closing interface 320 of the virtual closing system 300 during the closing process to sign a mortgage agreement electronically, while a remote notary verifies her identity and notarizes the document in real-time via a secure video call.

Next, at step 608, the controller 200 causes the virtual closing system 300 to capture an audio recording and/or a video recording of the virtual closing process, ensuring compliance and maintaining a verifiable record of the closing process and each individual step thereof. The virtual closing system 300 records the entire closing session, including document execution, interactions between users 410, 412, and/or the notarization process. For example, the video recording can capture verbal confirmation of the agreement terms, electronic signatures, and/or a notary’s certification, providing a legal safeguard for any disputes that may later arise.

Next, at step 610, the controller 200 causes the virtual closing system 300 to integrate the audio recording and/or video recording and the first dataset to generate a second dataset, e.g., creating a comprehensive closing record 450. This integration ensures that all recorded elements (e.g., signed contracts, notarized documents, and video recordings) are securely linked within a unified digital file, serving as a verifiable source of truth to ensure compliance, security, and/or future dispute resolution. For example, the second dataset may include the signed mortgage agreement, the recorded notary session, and/or a log of the closing. The second dataset may be embedded with digital signatures, which are cryptographically verified to confirm authenticity and prevent tampering. In addition, the second dataset may contain an embedded audit trail detailing when the documents 440 were accessed, reviewed, and/or signed by each party. For example, is the user 410 electronically signs the mortgage at 2:30 PM on Mar. 3rd, 2025, the virtual closing system 300 will log the timestamp, the signer's identity verification status, and/or the exact document version at the time of signing.

Next, at step 612, the controller 200 causes the virtual closing system 300 to record the second dataset on a distributed ledger system 340 in a decentralized and immutable format, ensuring that the closing data (e.g., closing record 450) is securely stored and protected against tampering. Blockchain technology is used to create an immutable record of the closing, with cryptographic hashes linking each transaction securely. For example, after the closing process is completed, the virtual closing system 300 records the second dataset on a blockchain ledger, ensuring that the transaction history remains permanent, verifiable, and resistant to fraud.

In aspects, the controller 200 causes the virtual closing system 300 to generate a title insurance policy, based on the second dataset, ensuring that the property’s title is protected against future claims or disputes. The virtual closing system 300 extracts key information from the second dataset, including property ownership history and executed agreements, to generate a digital title insurance policy automatically. For example, the virtual closing system 300 may issue a title insurance policy (e.g., title insurance record 362) that verifies the rightful owner of the property and/or protects them from potential claims against the title. This step may be automated with the help of the title insurance system 360.

Next, at step 614, the controller 200 causes the virtual closing system 300 to transmit the second dataset to a recording authority (e.g., a recording entity 430), ensuring that the finalized closing is officially recorded. The virtual closing system 300 securely transmits the second dataset, including all executed and notarized documents 440, to the appropriate government agency and/or land records office. For example, after the closing is complete, the virtual closing system 300 transmits the finalized deed and mortgage to the county recorder’s office, ensuring that the property transfer is legally documented in public records.

In aspects, the settlement system 350 may be employed to finalize a transaction and/or complete a payment. The settlement system 350 can integrate with quantum financial systems (QFS) to facilitate real-time, cross-border payments for property transactions using quantum encryption and digital asset verification. For example, when a user 410 412 a buyer completes the mortgage closing process, the virtual closing system 300 can trigger an instant, quantum-encrypted fund transfer to the seller via the QFS, bypassing traditional banking delays. QFS leverages quantum-resistant encryption and AI-based biometric identity verification to ensure that all parties in the transaction are genuine and authorized. For example, if a title agent attempts to modify or tamper with a property deed, the QFS will immediately detect inconsistencies and prevent fraudulent activities by cross-referencing blockchain records and biometric authentication. Moreover, the QFS operates on a decentralized, quantum-secure ledger, ensuring that real estate transaction records remain immutable and tamper-proof. For example, if the second dataset (signed mortgage agreements, video recordings, and metadata logs) is automatically stored on the QFS blockchain, providing an unalterable record for legal and regulatory verification.

In aspects, the virtual closing system 300 may operate as a licensed escrow service provider such that the settlement system 350 is configured to establish and manage one or more escrow accounts for a transaction. The settlement system 350 may securely hold funds in the escrow account during pre-closing and closing stages and may restrict disbursement until defined completion criteria are satisfied. The completion criteria may include verification of required participant identities, completion of execution of designated executable document versions, completion of remote online notarization events, confirmation of required transaction readiness checks, and approval of a disbursement sheet by designated participant roles.

In aspects, the settlement system 350 may generate and present a disbursement sheet identifying payees, disbursement amounts, funding sources, payment rails, and approval requirements. The system may require one or more role-based approvals prior to initiating fund distribution. Each approval may be recorded as an event record within the append-only log maintained by the data capture system 330. Upon satisfaction of the completion criteria and approval requirements, the settlement system 350 may automatically initiate disbursement and store payment confirmations as content-addressed artifacts linked to the closing manifest.

In aspects, transaction data, participant metadata, and document metadata may be stored in accordance with an industry-standard mortgage transaction data model. The data model may define standardized participant role identifiers, property identifiers, loan attributes, escrow attributes, and recording attributes to enable interoperability with lender systems, title systems, recording networks, and servicing platforms.

In aspects, the data capture system 330 may generate an audit package in a structured format that includes identity proofing results, credential analysis results, notarization information, timestamps, device identifiers, and a chronological activity history of participant actions and document changes. The structured format may include an XML representation aligned with a mortgage industry standard and may be incorporated into or referenced by the closing manifest to create a tamper-evident evidentiary record.

In aspects, the virtual closing system 300 may generate a standardized closing package that encapsulates executed document binaries, associated metadata, the audit package, payment confirmations, and recording confirmations using a standardized packaging format. The standardized closing package may include tamper-evident sealing information and may be distributed to authorized participants as a closing kit upon completion of the transaction.

In aspects, the closing interface 320 may provide a secure upload portal supporting multiple file formats and categorization of documents by transaction purpose. The system may maintain version control for each uploaded document by storing successive versions as separate binaries, recording corresponding event records identifying uploader identity, timestamp, and version identifier, and designating a specific version as an executable version eligible for electronic execution and notarization. The system may restrict execution to the designated executable version while preserving prior versions in the audit trail.

In aspects, the user interface 310 may provide meeting coordination features including calendar visualization, participant availability checking, automatic time zone normalization, invitation tracking, and readiness verification prior to initiation of a virtual closing session. Scheduling actions and participant acknowledgments may be stored as event records within the append-only log.

In aspects, the closing interface 320 may integrate a video conferencing module configured to support authenticated participant entry, waiting room controls, meeting lock controls, remote online notarization workflows, and recording hooks. Audio and video segments may be stored as content-addressed artifacts and referenced in the closing manifest, and notarization event records may include references to corresponding audio or video timestamps.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

Any of the herein described methods, programs, algorithms, or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, scripting languages, Visual Basic, metalanguages which themselves specify programs, and all first, second, third, fourth, fifth, or further generation computer languages. Also included are database and other data schemas, and any other meta-languages. No distinction is made between languages that are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above are also intended to be within the scope of the disclosure.

What is claimed is:

1. A system for fraud resistant closing record generation and verification, comprising:
a processor; and
a memory including instructions, which when executed by the processor, cause the system to:
verify an identity of a user using at least one of biometric verification, government-issued identification validation, or cryptographic authentication;
access a first dataset related to the virtual closing;
enable at least one of real-time electronic execution or real-time notarization of the first dataset;
capture at least one of an audio recording or a video recording of the virtual closing;
integrate the at least one audio recording or video recording and the first dataset to generate a second dataset;
record the second dataset on a distributed ledger system in a decentralized and immutable format; and
transmit the second dataset to a recording authority.

2. The system of claim 1, wherein the instructions, when executed by the processor, further cause the system to:
transmit a real-time transaction using a quantum financial system (QFS).

3. The system of claim 1, wherein the user includes at least one of an owner, a broker, a lender, an appraiser, a title insurance agent, a closing agent, or a notary.

4. The system of claim 1, wherein enabling the at least one of real-time electronic execution or real-time notarization of the first dataset includes using a smart contract stored on the distributed ledger system.

5. The system of claim 1, wherein recording the second dataset on the distributed ledger system includes recording the second dataset in an encrypted format on a blockchain ledger.

6. The system of claim 1, wherein the instructions, when executed by the processor, further cause the system to:
generate a cryptographic hash of the second dataset prior to transmission to the recording authority.

7. The system of claim 1, wherein the first dataset includes at least one of a deed, a transfer document, a mortgage, a note, a collateral document, an insurance policy, a title policy, a title report, or an affidavit.

8. The system of claim 1, wherein the instructions, when executed by the processor, further cause the system to:
generate a title insurance policy, based on the second dataset.

9. The system of claim 1, further comprising a gateway configured to directly interface with the recording authority.

10. The system of claim 9, wherein the recording authority is a county clerk office.

11. A virtual closing method, comprising:
verifying an identity of a user using at least one of biometric verification, government-issued identification validation, or cryptographic authentication;
accessing a first dataset related to the virtual closing;
enabling at least one of real-time electronic execution or real-time notarization of the first dataset;
capturing at least one of an audio recording or a video recording of the virtual closing;
integrating the at least one audio recording or video recording and the first dataset to generate a second dataset;
recording the second dataset on a distributed ledger system in a decentralized and immutable format; and
transmitting the second dataset to a recording authority.

12. The method of claim 11, further comprising:
transmitting a real-time transaction using a quantum financial system (QFS).

13. The method of claim 11, wherein user the includes at least one of an owner, a broker, a lender, an appraiser, a title insurance agent, a closing agent, or a notary.

14. The method of claim 11, wherein enabling the at least one of real-time electronic execution or real-time notarization of the first dataset includes using a smart contract stored on the distributed ledger system.

15. The method of claim 11, wherein recording the second dataset on the distributed ledger system includes recording the second dataset in an encrypted format on a blockchain ledger.

16. The method of claim 11, further comprising:
generating a cryptographic hash of the second dataset prior to transmission to the recording authority.

17. The method of claim 11, wherein the first dataset includes at least one of a deed, a transfer document, a mortgage, a note, a collateral document, an insurance policy, a title policy, a title report, or an affidavit.

18. The method of claim 11, further comprising:
generating a title insurance policy, based on the second dataset.

19. The method of claim 11, wherein a gateway is configured to directly interface with the recording authority.

20. A non-transitory computer readable storage medium including instructions that, when executed by a computer, cause the computer to perform a virtual closing method, comprising:
verifying an identity of a user using at least one of biometric verification, government-issued identification validation, or cryptographic authentication;
accessing a first dataset related to the virtual closing;
enabling at least one of real-time electronic execution or real-time notarization of the first dataset;
capturing at least one of an audio recording or a video recording of the virtual closing;
integrating the at least one audio recording or video recording and the first dataset to generate a second dataset;
recording the second dataset on a distributed ledger system in a decentralized and immutable format; and
transmitting the second dataset to a recording authority.
